(19) United States
(12) Patent Application Publication
(10) Pub. No.: US 2013/0267668 A1
(43) Pub. Date: Oct. 10, 2013

(54) POLYMERIZATION OF FLUORINATED VINYL MONOMERS IN A BIPHASIC REACTION MEDIUM

(71) Applicant: E I DU PONT DE NEMOURS AND COMPANY, Wilmington, DE (US)

(72) Inventors: Brian D. Mather, Newark, DE (US); Mark Brandon Shiflett, Wilmington, DE (US)

(73) Assignee: E I DU PONT DE NEMOURS AND COMPANY, Wilmington, DE (US)

(21) Appl. No.: 13/858,159

(22) Filed: Apr. 8, 2013

Related U.S. Application Data
(60) Provisional application No. 61/621,610, filed on Apr. 9, 2012.

(51) Int. Cl. C08F 114/20

(52) U.S. Cl. CPC C08F 114/20
USPC 526/193; 526/204

(57) ABSTRACT

An improved process for polymerization of a fluorinated vinyl monomer to produce a fluorinated polymer is described. The polymerization process comprises the free radical polymerization of a fluorinated vinyl monomer in a biphasic reaction medium, which comprises an ionic liquid containing a fluorinated vinyl monomer and an aqueous solution comprising a water-soluble free radical initiator. The ionic liquid is used to store quantities of the vinyl monomer, due to the high solubility of the vinyl monomer in the ionic liquid, thereby reducing the pressure required for the polymerization.

This application claims priority under 35 U.S.C. §119(e) from, and claims the benefit of, U.S. Provisional Application No. 61/621,610 filed 9 Apr. 2012, which is by this reference incorporated in its entirety as a part hereof for all purposes.

### TECHNICAL FIELD

The invention relates to a process for polymerization of fluorinated vinyl monomers wherein free radical polymerization is done in a biphasic reaction medium comprising an ionic liquid and an aqueous solution.

### BACKGROUND

Fluorinated vinyl monomers, such as vinyl fluoride and vinylidene fluoride, are widely used to make polymers and copolymers that are useful in many applications. For example, poly(vinyl fluoride) finds wide use as a protective or decorative coating on substances such as cellulosics, flexible vinyls, plastics, rubbers, and metals. Additionally, poly(vinyl fluoride) transparent film is used as the cover for solar plate collectors and photovoltaic cells. Poly(vinylidene fluoride) is used as a coating for metallic roofing, window frames, panel siding, and wire insulation. The polymers and copolymers of fluorinated vinyl monomers are typically produced by free radical polymerization in an aqueous solution at high pressure. For example, poly(vinyl fluoride) can be produced by free radical polymerization of vinyl fluoride in an aqueous medium at a temperature between 50° C. and 150° C. and a pressure of 3.4 to 34.4 MPa using catalysts such as peroxides or azo compounds. Additionally, vinyl fluoride can be polymerized using a continuous process, as described in U.S. Pat. No. 3,265,678. Vinylidene fluoride can be polymerized in an aqueous medium using a variety of free radical initiators, such as, di-t-butyl peroxide (U.S. Pat. No. 3,193,539), peroxy dicarbonates and peroxy esters (GB 1,094,558), and disuccinic acid. High pressure is used in these processes to increase the solubility of the fluorinated vinyl monomer in water; however, the high pressure limits the size of the reactor used to make the polymers, thereby limiting capacity. Additionally, there is a high initial capital cost associated with the high pressure reactor that is required for the process.

Therefore, the need exists for a process for polymerizing fluorinated vinyl monomers at lower pressure to increase production capacity and reduce cost.

### SUMMARY

The present invention addresses the stated need by providing a process for polymerizing fluorinated vinyl monomers wherein free radical polymerization is done in a biphasic reaction medium comprising an ionic liquid and an aqueous solution.

Accordingly, one embodiment provides a process for polymerization of a fluorinated vinyl monomer comprising the steps of:
a) providing a biphasic reaction medium comprising an ionic liquid containing a fluorinated vinyl monomer and an aqueous solution comprising a water-soluble free radical initiator; and
b) agitating the biphasic reaction mixture at a temperature of about 25° C. to about 250° C. and a pressure of about 2.5 MPa to about 100 MPa to produce a product mixture comprising a fluorinated polymer;
wherein:
   (i) the fluorinated vinyl monomer is selected from the group consisting of C₂H₃F, C₂H₂F₂, C₂HF₃, C₃HF₅, C₃H₂F₄, C₃H₃F₃, C₃H₄F₂, C₃H₅F, and mixtures thereof; and
   (ii) the ionic liquid comprises an anion and a cation, the cation is selected from the group consisting of cations represented by the structures of the following formulae:

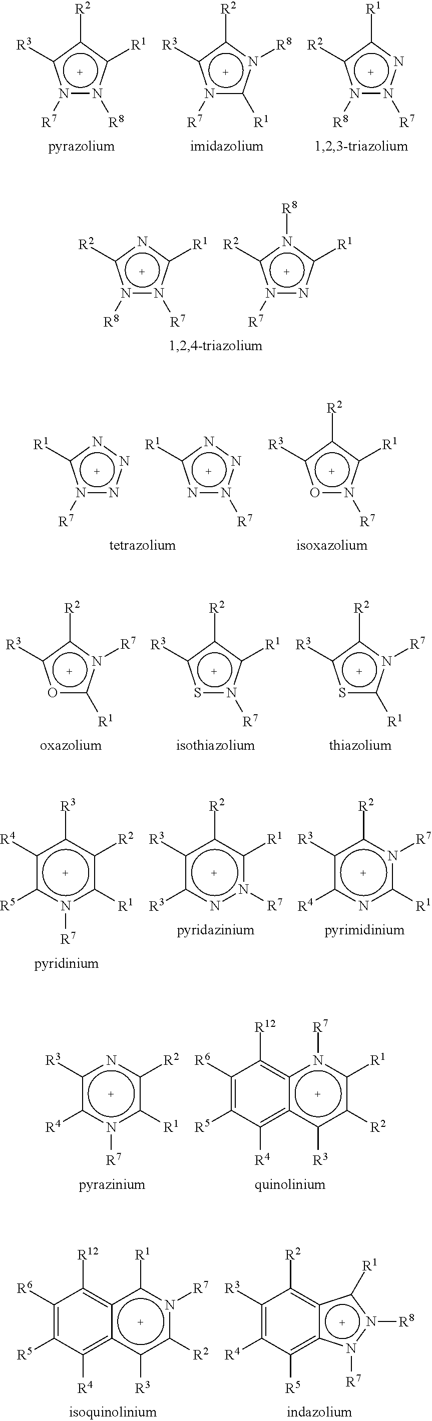

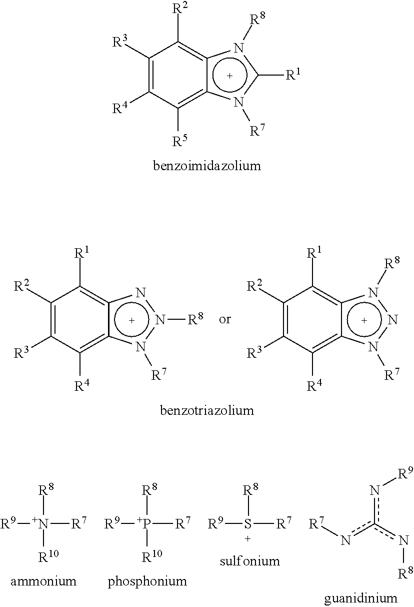

wherein:

A) R¹, R², R³, R⁴, R⁵, R⁶, and R¹² are independently selected from the group consisting of:
(I) H,
(II) halogen,
(III) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
(IV) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(V) C₆ to C₂₀ unsubstituted aryl, or C₁ to C₂₅ unsubstituted heteroaryl having one to three heteroatoms independently selected from the group consisting of O, N, Si and S;
(VI) C₆ to C₂₅ substituted aryl, or C₁ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (a) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
   (b) OH,
   (c) NH₂, and
   (d) SH; and
(VII) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4;

B) R⁷, R⁸, R⁹, and R¹⁰ are independently selected from the group consisting of:
(VIII) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
(IX) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(X) C₆ to C₂₅ unsubstituted aryl, or C₁ to C₂₅ unsubstituted heteroaryl having one to three heteroatoms independently selected from the group consisting of O, N, Si and S; and C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
   —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
   OH,
   NH₂, and
   SH; and
(XI) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and

C) optionally at least two of R¹, R², R³, R⁴, R⁵, R⁶, R⁷, R⁸, R⁹, and R¹⁰ can together form a cyclic or bicyclic alkanyl or alkenyl group.

### BRIEF DESCRIPTION OF THE DRAWING

FIG. 1 is a flow diagram of an exemplary system for use in the process for polymerization of a fluorinated vinyl monomer disclosed herein.

### DETAILED DESCRIPTION

As used above and throughout the description of the invention, the following terms, unless otherwise indicated, shall be defined as follows:

The term “fluorinated vinyl monomer” as used herein, refers to a vinyl monomer containing 2 or 3 carbon atoms selected from the group consisting of C₂H₃F, C₂H₂F₂, C₂HF₃, C₃HF₅, C₃H₂F₄, C₃H₃F₃, C₃H₄F₂, C₃H₅F, and mixtures thereof. Exemplary fluorinated vinyl monomers include, but are not limited to, HFC═CH₂ (vinyl fluoride), HFC═CHF, H₂C═CF₂ (vinylidene fluoride), and HFC═CH—CH₃.

The term “biphasic reaction medium” as used herein, refers to a reaction medium formed by combining two immiscible phases. One phase is an ionic liquid that is immiscible with water and the second phase is an aqueous solution.

The term “product mixture” as used herein, refers to the mixture resulting from the polymerization process disclosed herein. The product mixture comprises the fluorinated polymer produced, the ionic liquid, and water, and may contain some unreacted fluorinated vinyl monomer. The product mixture may be in the form of an emulsion, a slurry, or a multi-phase system comprising an ionic liquid phase, the fluorinated polymer and a water-rich phase. In the multi-phase system, the fluorinated polymer may be in the ionic liquid phase, the water-rich phase, or at the interface between the two phases.

The term “emulsion” as used herein, refers to a fluid colloidal system in which droplets or particles of one phase (i.e., ionic liquid, fluorinated polymer or water), are dispersed in a fluid continuous phase (i.e., water or ionic liquid). An emulsion as used herein, may comprise ionic liquid droplets dispersed in water, fluorinated polymer particles dispersed in ionic liquid, fluorinated polymer particles dispersed in water, water droplets dispersed in ionic liquid, and combinations thereof.

The term “slurry” as used herein, refers to a high viscosity emulsion or suspension.

The terms “free radical initiator” and “radical initiator” are used interchangeably herein to refer to a chemical compound that can generate free radical species (i.e., chemical species having an unpaired electron) under mild conditions and promote radical reactions.

The term “water-soluble free radical initiator” refers to a free radical initiator that is sufficiently soluble in water to produce a concentration of at least 0.001 wt %.

Disclosed herein is a process for polymerization of a fluorinated vinyl monomer to produce a fluorinated polymer. The polymerization process comprises the free radical polymerization of the fluorinated vinyl monomer in a biphasic reaction medium, which comprises an ionic liquid containing a fluorinated vinyl monomer and an aqueous solution containing a water-soluble free radical initiator. The ionic liquid is used to store quantities of the vinyl monomer, due to the high solubility of the vinyl monomer in the ionic liquid, thereby reducing the pressure required for the polymerization. As the polymerization reactions proceeds in the aqueous phase, the vinyl monomer is continuously desorbed from the ionic liquid into the aqueous phase.

The process for polymerization of a fluorinated vinyl monomer disclosed herein comprises the following steps. First, a biphasic reaction medium is formed by combining an ionic liquid, a fluorinated vinyl monomer, an aqueous solution, and a water-soluble free radical initiator. The biphasic reaction medium is typically formed in a high pressure reaction vessel. The biphasic reaction mixture can be formed by combining the aforementioned components in any order. For example, the fluorinated vinyl monomer gas may be dissolved in the ionic liquid by adding the gas to the ionic liquid under pressure. Alternatively, the fluorinated vinyl monomer gas may be condensed into the reaction vessel at low temperature and combined with the ionic liquid. The aqueous solution may be prepared by dissolving the water-soluble free radical initiator in water. The two phases may then be combined in the reaction vessel. Alternatively, the ionic liquid and the aqueous solution containing the water-soluble free radical initiator may be combined in the reaction vessel, and then the fluorinated vinyl monomer gas may be added. In one embodiment, the aqueous solution containing the water-soluble free radical initiator is continuously added to the reaction vessel containing the ionic liquid and the fluorinated vinyl monomer. In this embodiment, the rate of addition of the aqueous solution containing the water-soluble free radical initiator may be varied to control the rate of polymerization.

The relative amount of the ionic liquid and the aqueous solution in the biphasic reaction mixture varies depending on several factors, such as the fluorinated vinyl monomer and the amount of fluorinated vinyl monomer used in the polymerization process. The amount of the aqueous solution in the biphasic reaction medium may be about 5% to about 95%, more particularly, about 15% to about 80%, and more particularly, about 25% to about 70% by weight relative to the total weight of the biphasic reaction medium.

The fluorinated vinyl monomer is selected from the group consisting of C₂H₃F, C₂H₂F₂, C₂HF₃, C₃HF₅, C₃H₂F₄, C₃H₃F₃, C₃H₄F₂, C₃H₅F, and mixtures thereof. These monomers exist as a gas at ambient conditions and have a relatively low solubility in water. In one embodiment, the fluorinated vinyl monomer is vinyl fluoride (HFC═CH₂). In another embodiment, the fluorinated vinyl monomer is vinylidene fluoride (H₂C═CF₂).

Ionic liquids suitable for use as disclosed herein can, in principle, be any ionic liquid that absorbs fluorinated vinyl monomers; however, ionic liquids that have minimal absorption of fluorinated vinyl monomers will be less effective. Ideally, ionic liquids having high absorption of fluorinated vinyl monomers are desired for efficient use as described herein. Additionally, mixtures of two or more ionic liquids may be used.

Many ionic liquids are formed by reacting a nitrogen-containing heterocyclic ring, preferably a heteroaromatic ring, with an alkylating agent (for example, an alkyl halide) to form a cation. Examples of suitable heteroaromatic rings include substituted pyridines and imidazoles. These rings can be alkylated with virtually any straight, branched or cyclic C₁₋₂₀ alkyl group, but preferably, the alkyl groups are C₁₋₁₆ groups. Various other cations such as ammonium, phosphonium, sulfonium, and guanidinium may also be used for this purpose. Ionic liquids suitable for use herein may also be synthesized by salt metathesis, by an acid-base neutralization reaction or by quaternizing a selected nitrogen-containing compound; or they may be obtained commercially from several companies such as Merck (Darmstadt, Germany), BASF (Mount Olive, N.J.), Fluka Chemical Corp. (Milwaukee, Wis.), and Sigma-Aldrich (St. Louis, Mo.). For example, the synthesis of many ionic liquids is described by Shiflett et al. (U.S. Patent Application Publication No. 2006/0197053.

Representative examples of ionic liquids suitable for use herein are included among those that are described in sources such as J. Chem. Tech. Biotechnol., 68:351-356 (1997); Chem. Ind., 68:249-263 (1996); J. Phys. Condensed Matter, 5: (supp 34B):B99-B106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references cited therein). In one embodiment, a library, i.e., a combinatorial library, of ionic liquids may be prepared, for example, by preparing various alkyl derivatives of a quaternary ammonium cation, and varying the associated anions.

Ionic liquids suitable for use herein comprise an anion and a cation. The cation is selected from the group consisting of cations represented by the structures of the following formulae:

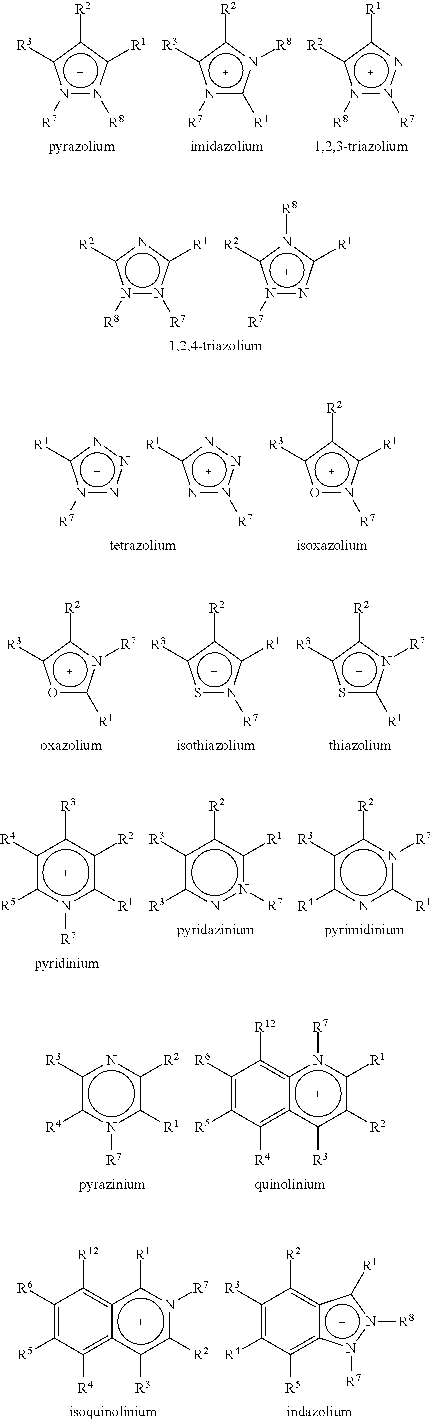

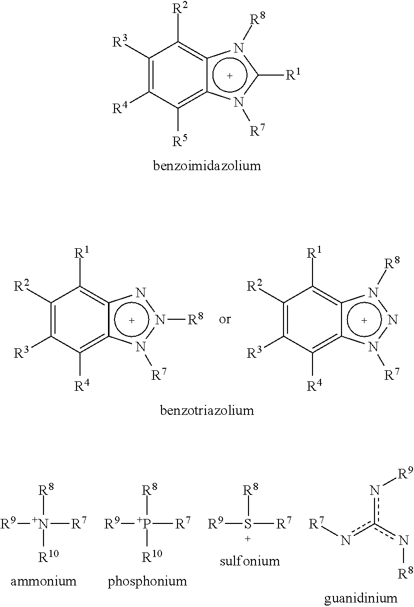

wherein:

a) R¹, R², R³, R⁴, R⁵, R⁶, and R¹² are independently selected from the group consisting of:
(i) H,
(ii) halogen,
(iii) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₁ to C₂₅ unsubstituted heteroaryl having one to three heteroatoms independently selected from the group consisting of O, N, Si and S;
(vi) C₆ to C₂₅ substituted aryl, or C₁ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (A) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
   (B) OH,
   (C) NH₂, and
   (D) SH; and
(vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4;

b) R⁷, R⁸, R⁹, and R¹⁰ are independently selected from the group consisting of:
(ix) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
(x) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xi) C₆ to C₂₅ unsubstituted aryl, or C₁ to C₂₅ unsubstituted heteroaryl having one to three heteroatoms independently selected from the group consisting of O, N, Si and S; and C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (E) CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
   (F) OH,
   (G) NH₂, and
   (H) SH; and
(xii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and

c) optionally at least two of R¹, R², R³, R⁴, R⁵, R⁶, R⁷, R⁸, R⁹, and R¹⁰ can together form a cyclic or bicyclic alkanyl or alkenyl group.

In one embodiment, the ionic liquid comprises an anion selected from one or more members of the group consisting of: [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, Cl⁻, Br⁻, I⁻, SCN⁻, a fluorinated anion.

In one embodiment, the ionic liquid comprises a fluorinated anion. Suitable fluorinated anions are described by Harmer et al. (U.S. Pat. No. 7,544,813), and include, but are not limited to, 1,1,2,2-tetrafluoroethanesulfonate; 2-chloro-1,1,2-trifluoroethanesulfonate; 1,1,2,3,3,3-hexafluoropropanesulfonate; 1,1,2-trifluoro-2-(trifluoromethoxy)ethanesulfonate; 1,1,2-trifluoro-2-(pentafluoroethoxy)ethanesulfonate; 2-(1,2,2,2-tetrafluoroethoxy)-1,1,2,2-tetrafluoroethanesulfonate; 2-(1,1,2,2-tetrafluoroethoxy)-1,1,2,2-tetrafluoroethanesulfonate; 2-(1,1,2,2-tetrafluoro-2-iodoethoxy)-1,1,2,2-tetrafluoroethanesulfonate; 1,1,2,2-tetrafluoro-2-(pentafluoroethoxy)ethanesulfonate; N,N-bis(1,1,2,2-tetrafluoroethanesulfonyl)imide; and N,N-bis(1,1,2,3,3,3-hexafluoropropanesulfonyl)imide.

In one embodiment, the ionic liquid comprises a cation selected from one or more members of the group consisting of pyridinium, pyridazinium, pyrimidinium, pyrazinium, imidazolium, pyrazolium, thiazolium, oxazolium, triazolium, phosphonium, ammonium, and guanidinium.

In another embodiment, the ionic liquid comprises an anion selected from one or more members of the group consisting of acetate, aminoacetate, ascorbate, benzoate, catecholate, citrate, dialkylphosphate, formate, fumarate, gallate, glycolate, glyoxylate, iminodiacetate, isobutyrate, kojate, lactate, levulinate, oxalate, pivalate, propionate, pyruvate, salicylate, succinamate, succinate, tiglate, tetrafluoroborate, tetrafluoroethanesulfonate, tropolonate, [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆], [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃], [CF₃CF₂OCF₂CF₂SO₃]⁻, [(CF₂HCF₂SO₂)₂N], [(CF₃CFHCF₂SO₂)₂N]⁻, F⁻, and anions represented by the structure of the following formula:

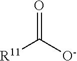

wherein R¹¹ is selected from the group consisting of:
(i) —CH₃, —C₂H₅, or C₁ to C₁₇ straight-chain, branched or cyclic alkane or alkene, optionally substituted with at least one member selected from the group consisting of Cl, Br, F, I, OH, NH₂ and SH;
(ii) —CH₃, —C₂H₅, or C₁ to C₁₇ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₁ to C₁₇ unsubstituted heteroaryl having one to three heteroatoms independently selected from the group consisting of O, N, Si and S; and
(iv) C₆ to C₁₀ substituted aryl, or C₁ to C₁₇ substituted heteroaryl having one to three heteroatoms independently selected from the group consisting of O, N, Si and S; and wherein said substituted aryl or substituted heteroaryl has one to three substituents independently selected from the group consisting of:
   (A) —CH₃, —C₂H₅, or C₁ to C₁₇ straight-chain, branched or cyclic alkane or alkene, optionally substituted with at least one member selected from the group consisting of Cl, Br, F, I, OH, NH₂ and SH,
   (B) OH,
   (C) NH₂, and
   (D) SH.

In one embodiment, the ionic liquid is selected from one or more members of the group consisting of trihexyltetradecyl phosphonium bis(trifluoromethanesulfonyl)imide, 1-butyl-3-methylimidazolium dicyanimide, 1-butyl-3-methylimidazolium 1,1,2,3,3,3-hexafluoropropanesulfonate, 1-ethyl-3-methylimidazolium bis(trifluoromethylsulfonyl)imide, 1-butyl-3-methylpyridinium tetrafluoroborate, and 1-methyl-3-octylimidazolium 1,1,2,2-tetrafluoroethanesulfonate. In another embodiment, the ionic liquid is trihexyltetradecyl phosphonium bis(trifluoromethanesulfonyl)imide.

A variety of water-soluble free radical initiators that are known in the art can be used in the process disclosed herein. Suitable free radical initiators include, but are not limited to, organic peroxides, such as diacetyl peroxide; hydroperoxides, such as t-butyl hydroperoxide and acetyl hydroperoxide; water-soluble salts of inorganic peracids, such as ammonium persulfate, potassium persulfate, potassium perphosphate, and potassium percarbonate; and azo compounds, such as α-azoisobutryamidine hydrochloride, 2,2′-diguanyl-2,2′-azopropane dihydrochloride, 4,4-azobis(4-cyanovaleric acid), 2,2′-diguanyl-2,2′-azobutane dihydrochloride, azo-α-cyclopropylpropionamide hydrochloride, 2,2′-azobis(2-methylpropionamidine) dihydrochloride (sold under the tradename V-50 by Wako Chemical Co., Richmond, Va.), and substituted azonitrile compounds such as those sold under the tradename Vazo® free radical sources by E.I. du Pont de Nemours and Co. (Wilmington, Del.). The amount of the free radical initiator used in the aqueous solution can vary from about 0.001% to about 5% based on the weight of the monomer used.

The bipasic reaction medium may also contain one or more other vinyl monomers such as for example, vinyl chloride, ethylene, propene, or vinylidene chloride, to produce copolymers. Additionally, the biphasic reaction mixture may contain various additives such as iodine or compounds containing iodine, as described by Trautvetter et al. (U.S. Pat. No. 3,755,246), mono-olefins such as propylene and butylenes, as described by Hecht (U.S. Pat. No. 3,265,678), and surfactants.

In the next step of the process, the biphasic reaction medium is agitated at a temperature and pressure and for a time sufficient to form a product mixture comprising a fluorinated polymer product. The product mixture may be in the form of a slurry, an emulsion, or a multi-phase system comprising an ionic liquid phase, the fluorinated polymer, and a water-rich phase. Agitation may be done by any suitable method known in the art. For example, a stirring device such as a motor-driven stirrer, a high speed mixer or homogenizer may be used. Alternatively, a shaking or rocking motion may be imparted to the reaction vessel. The temperature used in the process depends on several factors. The lower temperature limit depends on the initiation temperature of the free radical initiator used, i.e., the temperature at which decomposition of the initiator results in a suitable rate of polymerization. The upper temperature limit depends on the temperature at which the fluorinated vinyl monomer or the fluorinated polymer produced undergoes a significant degree of thermal decomposition, for example about 250° C. for vinyl fluoride. Typically, the temperature used in the process is about 50° C. to about 200° C., more particularly about 50° C. to about 150° C., and more particularly, about 50° C. to about 100° C. The pressure used in the process disclosed herein is in the range of about 2.5 MPa to about 100 MPa, more particularly about 2.5 MPa to about 50 MPa, and more particularly, about 2.5 MPa to about 10 MPa.

The fluorinated polymer may be recovered from the product mixture by filtration, centrifugation, coagulation, flocculation, decantation, or the like. The recovered fluorinated polymer in the form of a powder or cake may be washed with water or an organic solvent and dried.

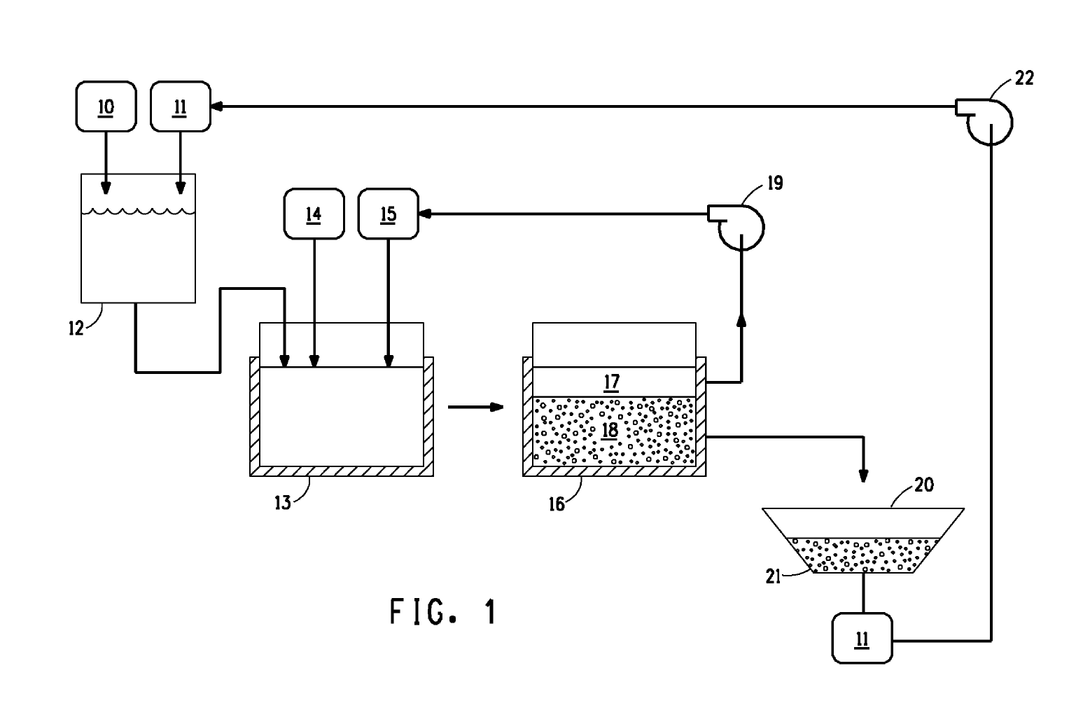

One exemplary system for use in the process for polymerization of a fluorinated vinyl monomer disclosed herein is shown in FIG. 1. Referring to FIG. 1, the fluorinated vinyl monomer 10 is dissolved in the ionic liquid 11 in a tank 12, which is equipped with a mixer (not shown). The ionic liquid containing dissolved fluorinated vinyl monomer is transferred to a high pressure reaction vessel 13, which is equipped with a mixer (not shown). The initiator and water are also added to the reaction vessel 13 from supply tanks 14 and 15, respectively, forming the biphasic reaction medium. Alternatively, the initiator dissolved in the water may be added from a single supply tank. The biphasic reaction medium is agitated at the desired temperature and pressure. As the temperature of the biphasic medium increases, the fluorinated vinyl monomer begins to desorb from the ionic liquid and the initiator starts the polymerization reaction in the aqueous solution phase, leading to the formation of a product mixture comprising the fluorinated polymer product. After a time sufficient to form the fluorinated polymer product, the reaction vessel 14 is cooled and agitation is stopped, allowing the product mixture to separate into phases, as shown in 16, which shows reaction vessel 14 after the completion of the reaction. The water-rich phase 17 rises to the top of the reaction vessel 16, while the ionic liquid 18 containing the fluorinated polymer produced by the polymerization settles to the bottom of the reaction vessel 16 due to the higher density of the ionic liquid phase. The water phase is pumped back into supply tank 15 by pump 19 and recycled. The ionic liquid containing the fluorinated polymer is decanted to a filter 20 where the fluorinated polymer 21 is collected in the filter and the ionic liquid 11 is pumped back into tank 12 by pump 22 and recycled.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “hr” means hour(s), “mL” means milliliter(s), “μL” means microliter(s), “g” means gram(s), “mg” means milligram(s), “μg” means microgram(s), “wt %” means weight percent, “psi” means pounds per square inch, “Pa” means pascal(s), “kPa” means kilopascal(s), and “MPa” means megapascal(s), ¹H NMR” means proton nuclear magnetic resonance spectroscopy.

### Materials

Trihexyltetradecyl phosphonium bis(trifluoromethanesulfonyl)imide (6,6,6,14-P Tf₂N), trihexyltetradecylphosphonium bis(trifluoromethylsulfonyl)imide [6,6,6,14-P][Tf2N], lithium 1,1,2,2-tetrafluoroethanesulfonate (Li TFES),1-butyl-4-methylpyridinium tetrafluoroborate [bmPy][BF4], 1-octyl-3-methylimidazolium tetrafluoroethanesulfonate [omim][TFES], and 1-octyl-3-methyl imidazoleum 1,1,2,2-tetrafluoroethanesulfonate (OmIm TFES) were obtained from Iolitec Inc. (Tuscaloosa, Ala.). 1-butyl-3-methylimidazolium dicyanimide [bmim][N(CN)2] was obtained from Fluka (St. Louis, Mo.). 1-ethyl-3-methylimidazolium bistrifluoromethylsulfonylimide [emim][Tf2N] was obtained from Covalent Associates, Inc. (Corvallis, Oreg.). 1-butyl-3-methylimidazolium hexafluoropropanesulfonate [bmim][HFPS] was from E.I. du Pont de Nemours and Co. (Wilmington, Del.). Vazo-67 was obtained from E.I. du Pont de Nemours and Co. (Wilmington, Del.). Vinyl fluoride (VF) was manufactured by E.I. du Pont de Nemours and Co. VF was stabilized with d-limonene which was removed by passing the gas through silica gel. The initiator V-50 was obtained from Wako Chemical Co. (Richmond, Va.).

### Solubility Measurements

Solubility measurements were made using a glass equilibrium cell (E. W. Slocum, Ind. Eng. Chem. Fundam. (1975) 14, 126). The glass equilibrium cell had a known volume and was agitated so that the upper phase (gas or liquid) mixed into the lower liquid phase. A known amount of ionic liquid was loaded into the cell and the cell was evacuated with heating to degas and remove any residual water in the ionic liquid. Knowing the density of the ionic liquid, the volume of the ionic liquid was calculated, and the difference from the initial glass cell volume was used to calculate the vapor space volume. A known amount of gas was fed into the cell and the temperature was held constant with a circulating oil bath. The pressure of the cell was measured and recorded. When the pressure was determined to no longer change, the cell was at equilibrium and the amount of gas absorbed was calculated by taking into account the amount of gas in the equilibrium cell vapor space. Further discussion of this equipment and procedure is available in W. Schotte, Ind. Eng. Chem. Process Des. Dev. (1980) 19, 432-439.

### Example 1

### Solubility of vinyl fluoride (VF) in 1-butyl-3-methylimidazolium dicyanimide ([bmim][dca])

A solubility study was made at temperatures of 24.81° C. and 100.03° C. over a pressure range from 0.1 to about 4.3 MPa where the solubilities (x_{meas.}) were measured using the glass equilibrium cell and method described above.

Tables 1 and 2 provide data for temperature (T), pressure (P), and xₘₑₐₛ at temperatures of 24.81° C. and 100.03° C., respectively.

TABLE 1
Solubility of Vinyl Fluoride in [bmim][dca] at 24.81° C.

| T | P | x_{meas.} |
|---|---|---|
| (° C.) | (MPa) | (mole fraction) |
| 24.81 | 0.1200 | 0.0259 |
| 24.81 | 0.3992 | 0.0822 |
| 24.81 | 0.6702 | 0.1333 |
| 24.81 | 1.0432 | 0.1994 |
| 24.81 | 1.4300 | 0.2629 |
| 24.81 | 1.7313 | 0.3091 |
| 24.81 | 1.9871 | 0.3470 |
| 24.81 | 2.2339 | 0.3824 |
| 24.81 | 2.4869 | 0.4175 |

TABLE 2
Solubility of Vinyl Fluoride in [bmim][dca] at 100.03° C.

| T | P | x_{meas.} |
|---|---|---|
| (° C.) | (MPa) | (mole fraction) |
| 100.03 | 0.4385 | 0.0289 |
| 100.03 | 0.9280 | 0.0583 |
| 100.03 | 1.3762 | 0.0854 |
| 100.03 | 1.9236 | 0.1152 |
| 100.03 | 2.3601 | 0.1381 |
| 100.03 | 2.8117 | 0.1601 |
| 100.03 | 3.3508 | 0.1845 |
| 100.03 | 3.7983 | 0.2033 |
| 100.03 | 4.2616 | 0.2214 |

### Example 2

### Solubility of vinyl fluoride (VF) in 1-butyl-3-methylimidazolium 1,1,2,3,3,3-hexafluoropropanesulfonate ([bmim][HFPS])

A solubility study was made at temperatures of 24.78° C. and 99.52° C. over a pressure range from 0.1 to about 3.7 MPa where the solubilities (x_{meas.}) were measured using the glass equilibrium cell and method described above.

Tables 3 and 4 provide data for T, P, and xₘₑₐₛ at temperatures of 24.78° C. and 99.52° C., respectively.

TABLE 3
Solubility of Vinyl Fluoride in [bmim][HFPS] at 24.78° C.

| T | P | x_{meas.} |
|---|---|---|
| (° C.) | (MPa) | (mole fraction) |
| 24.78 | 0.1124 | 0.0405 |
| 24.78 | 0.4413 | 0.1478 |
| 24.78 | 0.8350 | 0.2590 |
| 24.78 | 1.1921 | 0.3487 |
| 24.78 | 1.5651 | 0.4345 |
| 24.78 | 1.9305 | 0.5132 |
| 24.78 | 2.2484 | 0.5796 |
| 24.78 | 2.4842 | 0.6301 |

TABLE 4
Solubility of Vinyl Fluoride in [bmim][HFPS] at 99.52° C.

| T | P | x_{meas.} |
|---|---|---|
| (° C.) | (MPa) | (mole fraction) |
| 99.52 | 0.5019 | 0.0574 |
| 99.52 | 0.9473 | 0.1042 |
| 99.52 | 1.3996 | 0.1475 |
| 99.52 | 1.8050 | 0.1836 |
| 99.52 | 2.2415 | 0.2199 |
| 99.52 | 2.6365 | 0.2508 |
| 99.52 | 3.1433 | 0.2869 |
| 99.52 | 3.7349 | 0.3257 |

### Example 3

### Solubility of vinyl fluoride (VF) in 1-ethyl-3-methylimidazolium bis(trifluoromethylsulfonyl)imide ([emim][Tf₂N])

A solubility study was made at temperatures of 4.83° C., 24.74° C. and 99.45° C. over a pressure range from 0.2 to about 4.2 MPa where the solubilities (x_{meas.}) were measured using the glass equilibrium cell and method described above.

Tables 5, 6 and 7 provide data for T, P, and xₘₑₐₛ at temperatures of 4.83° C., 24.74° C. and 99.45° C., respectively.

TABLE 5
Solubility of Vinyl Fluoride in [emim][Tf₂N] at 4.83° C.

| T | P | x_{meas.} |
|---|---|---|
| (° C.) | (MPa) | (mole fraction) |
| 4.83 | 0.1620 | 0.1020 |
| 4.83 | 0.3696 | 0.2142 |
| 4.83 | 0.5888 | 0.3171 |
| 4.83 | 0.8115 | 0.4106 |
| 4.83 | 1.0218 | 0.4914 |
| 4.83 | 1.2031 | 0.5580 |
| 4.83 | 1.3803 | 0.6222 |
| 4.83 | 1.5210 | 0.6729 |

TABLE 6
Solubility of Vinyl Fluoride in [emim][Tf₂N] at 24.74° C.

| T | P | x_{meas.} |
|---|---|---|
| (° C.) | (MPa) | (mole fraction) |
| 24.74 | 0.2613 | 0.1043 |
| 24.74 | 0.5185 | 0.1926 |
| 24.74 | 0.8646 | 0.2956 |
| 24.74 | 1.2328 | 0.3905 |
| 24.74 | 1.5217 | 0.4578 |
| 24.74 | 1.7602 | 0.5097 |
| 24.74 | 2.0215 | 0.5639 |
| 24.74 | 2.2546 | 0.6109 |
| 24.74 | 2.5083 | 0.6618 |

TABLE 7
Solubility of Vinyl Fluoride in [emim][Tf₂N] at 99.45° C.

| T | P | x_{meas.} |
|---|---|---|
| (° C.) | (MPa) | (mole fraction) |
| 99.45 | 0.4730 | 0.0594 |
| 99.45 | 0.9377 | 0.1130 |
| 99.45 | 1.3590 | 0.1569 |
| 99.45 | 1.6947 | 0.1894 |
| 99.45 | 2.0795 | 0.2238 |
| 99.45 | 2.4359 | 0.2538 |
| 99.45 | 2.8868 | 0.2892 |
| 99.45 | 3.4846 | 0.3317 |
| 99.45 | 4.2072 | 0.3773 |

### Example 4

### Solubility of vinyl fluoride (VF) in 1-butyl-3-methylpyridinium tetrafluoroborate ([bmPy][BF₄])

A solubility study was made at temperatures of 4.74° C., 24.80° C. and 100.03° C. over a pressure range from 0.1 to about 4.2 MPa where the solubilities (x_{meas.}) were measured using the glass equilibrium cell and method described above.

Tables 8, 9 and 10 provide data for T, P, and xₘₑₐₛ at temperatures of 4.74° C., 24.80° C. and 100.03° C., respectively.

TABLE 8
Solubility of Vinyl Fluoride in [bmPy][BF₄] at 4.74° C.

| T | P | x_{meas.} |
|---|---|---|
| (° C.) | (MPa) | (mole fraction) |
| 4.74 | 0.1248 | 0.0626 |
| 4.74 | 0.2910 | 0.1403 |
| 4.74 | 0.4330 | 0.2023 |
| 4.74 | 0.5792 | 0.2623 |
| 4.74 | 0.7508 | 0.3285 |
| 4.74 | 0.9308 | 0.3949 |
| 4.74 | 1.1204 | 0.4608 |
| 4.74 | 1.2990 | 0.5219 |
| 4.74 | 1.4417 | 0.5704 |

TABLE 9
Solubility of Vinyl Fluoride in [bmPy][BF₄] at 24.80° C.

| T | P | x_{meas.} |
|---|---|---|
| (° C.) | (MPa) | (mole fraction) |
| 24.80 | 0.1462 | 0.0470 |
| 24.80 | 0.4226 | 0.1281 |
| 24.80 | 0.7095 | 0.2041 |
| 24.80 | 1.0749 | 0.2916 |
| 24.80 | 1.3858 | 0.3595 |
| 24.80 | 1.6734 | 0.4181 |
| 24.80 | 1.9588 | 0.4732 |
| 24.80 | 2.2422 | 0.5255 |
| 24.80 | 2.4835 | 0.5689 |

TABLE 10
Solubility of Vinyl Fluoride in [bmPy][BF₄] at 100.03° C.

| T | P | x_{meas.} |
|---|---|---|
| (° C.) | (MPa) | (mole fraction) |
| 100.03 | 0.5474 | 0.0508 |
| 100.03 | 1.0246 | 0.0913 |
| 100.03 | 1.5810 | 0.1344 |
| 100.03 | 2.0022 | 0.1652 |
| 100.03 | 2.4394 | 0.1947 |
| 100.03 | 2.8379 | 0.2201 |
| 100.03 | 3.3157 | 0.2484 |
| 100.03 | 3.7266 | 0.2713 |
| 100.03 | 4.2272 | 0.2966 |

### Example 5

### Solubility of vinyl fluoride (VF) in 1-methyl-3-octylimidazolium 1,1,2,2-tetrafluoroethanesulfonate ([omim][TFES])

A solubility study was made at temperatures of 4.77° C., 24.82° C. and 100.04° C. over a pressure range from 0.1 to about 4.2 MPa where the solubilities (xₘₑₐₛ) were measured using the glass equilibrium cell and method described above.

Tables 11, 12 and 13 provide data for T, P, and xₘₑₐₛ at temperatures of 4.77° C., 24.82° C. and 100.04° C., respectively.

TABLE 11
Solubility of Vinyl Fluoride in [omim][TFES] at 4.77° C.

| T | P | x_{meas.} |
|---|---|---|
| (° C.) | (MPa) | (mole fraction) |
| 4.77 | 0.1365 | 0.0833 |
| 4.77 | 0.3289 | 0.1867 |
| 4.77 | 0.4537 | 0.2483 |
| 4.77 | 0.5861 | 0.3098 |
| 4.77 | 0.7550 | 0.3829 |
| 4.77 | 0.9756 | 0.4719 |
| 4.77 | 1.1700 | 0.5457 |
| 4.77 | 1.3121 | 0.5999 |
| 4.77 | 1.4362 | 0.6485 |

TABLE 12
Solubility of Vinyl Fluoride in [omim][TFES] at 24.82° C.

| T | P | x_{meas.} |
|---|---|---|
| (° C.) | (MPa) | (mole fraction) |
| 24.82 | 0.1972 | 0.0785 |
| 24.82 | 0.4778 | 0.1778 |
| 24.82 | 0.8143 | 0.2812 |
| 24.82 | 1.1218 | 0.3651 |
| 24.82 | 1.3920 | 0.4326 |
| 24.82 | 1.7223 | 0.5088 |
| 24.82 | 1.9912 | 0.5676 |
| 24.82 | 2.2725 | 0.6276 |
| 24.82 | 2.5414 | 0.6868 |

TABLE 13
Solubility of Vinyl Fluoride in [omim][TFES] at 100.04° C.

| T | P | x_{meas.} |
|---|---|---|
| (° C.) | (MPa) | (mole fraction) |
| 100.04 | 0.5185 | 0.0675 |
| 100.04 | 0.9935 | 0.1238 |
| 100.04 | 1.4734 | 0.1752 |
| 100.04 | 1.8285 | 0.2101 |
| 100.04 | 2.3249 | 0.2549 |
| 100.04 | 2.8193 | 0.2959 |
| 100.04 | 3.2585 | 0.3291 |
| 100.04 | 3.7052 | 0.3609 |
| 100.04 | 4.1589 | 0.3902 |

### Example 6, Comparative

### Polymerization of Vinyl Fluoride in Water

A 240 mL stainless steel shaker tube was loaded with 100 g of deionized water and 0.100 g of V-50 radical initiator. The tube was sealed, and then evacuated and refilled with nitrogen 3 times. Next, the tube was cooled using a dry ice bath to −78° C. and 15 g of vinyl fluoride gas was condensed into the tube. The tube was once again sealed, and heated to 80° C. for a period of 6 hours with vigorous shaking. During this time, pressure and temperature were monitored. The pressure decreased from 565 psi (3.90 MPa) to 218 psi (1.50 MPa) over the course of the reaction, while the temperature was maintained at 80° C., indicating significant consumption of the vinyl fluoride monomer. At the end of the reaction, the unreacted vinyl fluoride was vented into a fume hood, and the product was decanted into a sample jar. The product was an opaque white liquid. The yield of the polymerization was determined by evaporating the water from the product, and drying the resultant poly(vinyl fluoride) powder in a vacuum oven. The yield was determined to be 60%.

### Example 7, Comparative

### Polymerization of Vinyl Fluoride in the Ionic Liquid 6,6,6,14-P Tf₂N

A 240 mL stainless steel shaker tube was loaded with 68 g of the ionic liquid trihexyltetradecyl phosphonium bis(trifluoromethanesulfonyl)imide (6,6,6,14-P Tf₂N) and 0.100 g of Vazo® 67 radical initiator (E.I. du Pont de Nemours and Co.). The Vazo® 67 radical initiator was used because the V-50 radical initiator was found to be insoluble in 6,6,6,14-P Tf₂N. The tube was sealed, and then evacuated and refilled with nitrogen 3 times. Next, the tube was cooled using a dry ice bath to −78° C. and 15 g of vinyl fluoride gas was condensed into the tube. The tube was once again sealed, manually shaken, and allowed to sit for one hour to equilibrate. Next, the tube was heated to 80° C. for a period of 6 hours with vigorous shaking. During this time, pressure and temperature were monitored. The pressure decreased from a maximum of 400 psi (2.76 MPa) to 365 psi (2.52 MPa) over the course of the reaction, while the temperature was maintained at 80° C., indicating the consumption of some of the vinyl fluoride monomer. At the end of the reaction, the unreacted vinyl fluoride was vented into a fume hood, and the product was decanted into a sample jar. The product was a slightly cloudy, translucent liquid, suggesting the presence of a small amount of poly(vinyl fluoride), which is insoluble in 6,6,6,14-P Tf₂N. A few drops of the reaction mixture were dissolved in 2 mL CDCl₃ and a ¹H NMR spectrum was obtained. The NMR spectrum indicated the presence of small quantities of poly(vinyl fluoride), in addition to vinyl fluoride monomer and ionic liquid. No other products were observed.

### Example 8

### Polymerization of Vinyl Fluoride in a Biphasic Mixture of Water and the Ionic Liquid 6,6,6,14-P Tf₂N

A 125 mL autoclave with baffles and a flat blade turbine was loaded with 50 g of trihexyltetradecyl phosphonium bis(trifluoromethanesulfonyl)imide (6,6,6,14-P Tf₂N). The autoclave was sealed, and then evacuated and refilled with nitrogen 3 times. Next, the autoclave was cooled using a dry ice bath to −78° C., and vinyl fluoride gas, 15 g, was condensed into the autoclave. Next, the autoclave was heated to 80° C. and stirred at 600 rpm, and V-50 initiator was injected in an aqueous solution (0.100 g in 25 mL of water) at a rate of 1 mL/min. The water-soluble initiator was chosen to promote polymerization in the aqueous phase because it was clear from Example 7 that polymerization did not proceed well in the ionic liquid phase. Heating and stirring were continued for a period of 6 hours. During this time, the pressure and temperature were monitored. The pressure decreased from a maximum of 643 psi (4.43 MPa) to 619 psi (4.27 MPa) over the course of the reaction, while the temperature was maintained at 80° C., indicating the consumption of some of the vinyl fluoride monomer. At the end of the reaction, the unreacted vinyl fluoride was vented into a fume hood, and the product was decanted into a sample jar. The product was an opaque emulsion, suggesting the presence of poly(vinyl fluoride). The product was centrifuged and three layers were formed. The top layer was water, the bottom layer was ionic liquid and the middle layer was polymer-rich ionic liquid. The polymer was precipitated from the polymer-rich ionic liquid layer into chloroform. Although the product yield was not quantified, it was visually judged to be markedly higher than the yield in the ionic liquid alone (Example 7, Comparative).

What is claimed is:

1. A process for polymerization of a fluorinated vinyl monomer comprising the steps of:
a) providing a biphasic reaction medium comprising an ionic liquid containing a fluorinated vinyl monomer and an aqueous solution comprising a water-soluble free radical initiator; and
b) agitating the biphasic reaction mixture at a temperature of about 25° C. to about 250° C. and a pressure of about 2.5 MPa to about 100 MPa to produce a product mixture comprising a fluorinated polymer;
wherein:
(i) the fluorinated vinyl monomer is selected from the group consisting of C₂H₃F, C₂H₂F₂, C₂HF₃, C₃HF₅, C₃H₂F₄, C₃H₃F₃, C₃H₄F₂, C₃H₅F, and mixtures thereof; and
(ii) the ionic liquid comprises an anion and a cation, said cation is selected from the group consisting of cations represented by the structures of the following formulae: 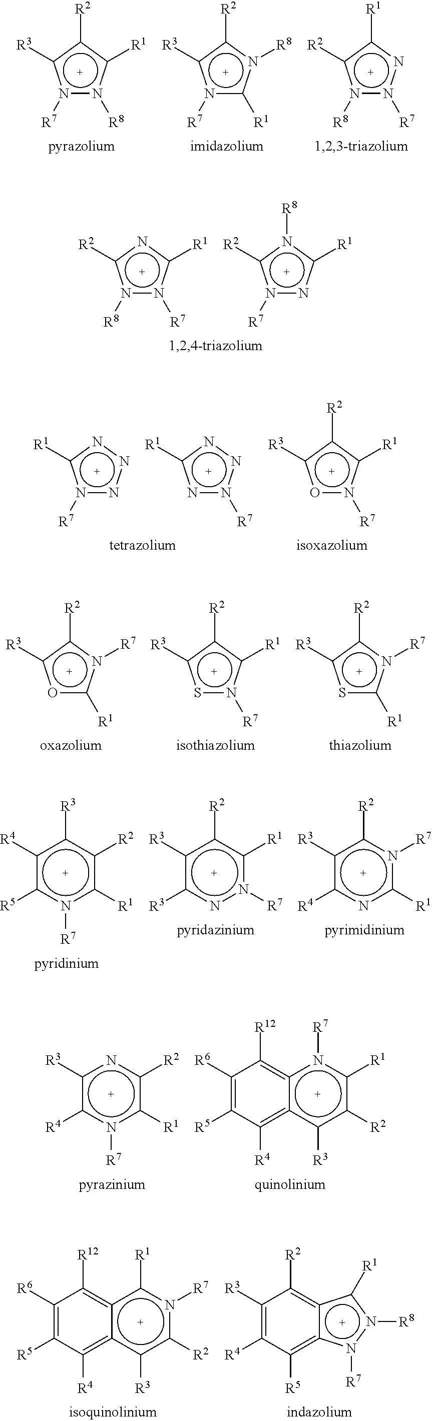 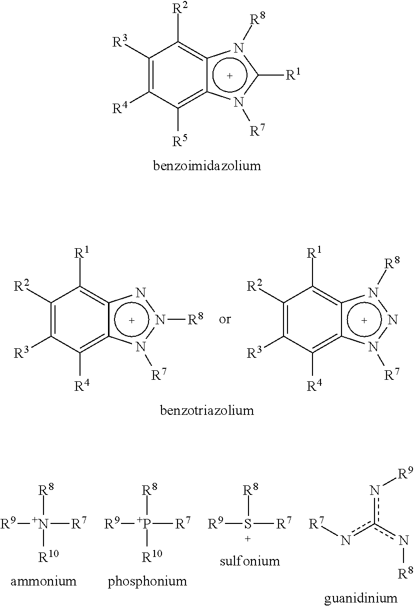
wherein:
A) R¹, R², R³, R⁴, R⁵, R⁶, and R¹² are independently selected from the group consisting of:
(I) H,
(II) halogen,
(III) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
(IV) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(V) C₆ to C₂₀ unsubstituted aryl, or C₁ to C₂₅ unsubstituted heteroaryl having one to three heteroatoms independently selected from the group consisting of O, N, Si and S;
(VI) C₆ to C₂₅ substituted aryl, or C₁ to C₂₅ substituted heteroaryl having one to three heteroatoms independently selected from the group consisting of O, N, Si and S; and wherein said substituted aryl or substituted heteroaryl has one to three substituents independently selected from the group consisting of:
(a) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
(b) OH,
(c) NH₂, and
(d) SH; and
(VII) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4;
B) R⁷, R⁸, R⁹, and R¹⁰ are independently selected from the group consisting of:
(VIII) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
(IX) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(X) C₆ to C₂₅ unsubstituted aryl, or C₁ to C₂₅ unsubstituted heteroaryl having one to three heteroatoms independently selected from the group consisting of O, N, Si and S; and C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
—CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
OH,
NH₂, and
SH; and
(XI) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
C) optionally at least two of R¹, R², R³, R⁴, R⁵, R⁶, R⁷, R⁸, R⁹, and R¹⁰ can together form a cyclic or bicyclic alkanyl or alkenyl group.

2. The process of claim 1 wherein the anion is selected from one or more members of the group consisting of: [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CUCl₂]⁻, Cl⁻, Br⁻, I⁻, SCN⁻, and a fluorinated anion.

3. The process of claim 2 wherein the fluorinated anion is selected from one or more members of the group consisting of 1,1,2,2-tetrafluoroethanesulfonate; 2-chloro-1,1,2-trifluoroethanesulfonate; 1,1,2,3,3,3-hexafluoropropanesulfonate; 1,1,2-trifluoro-2-(trifluoromethoxy)ethanesulfonate; 1,1,2-trifluoro-2-(pentafluoroethoxy)ethanesulfonate; 2-(1,2,2,2-tetrafluoroethoxy)-1,1,2,2-tetrafluoroethanesulfonate; 2-(1,1,2,2-tetrafluoroethoxy)-1,1,2,2-tetrafluoroethanesulfonate; 2-(1,1,2,2-tetrafluoro-2-iodoethoxy)-1,1,2,2-tetrafluoroethanesulfonate; 1,1,2,2-tetrafluoro-2-(pentafluoroethoxy)ethanesulfonate; N,N-bis(1,1,2,2-tetrafluoroethanesulfonyl)imide; and N,N-bis(1,1,2,3,3,3-hexafluoropropanesulfonyl)imide.

4. The process of claim 1 wherein the cation is selected from one or more members of the group consisting of pyridinium, pyridazinium, pyrimidinium, pyrazinium, imidazolium, pyrazolium, thiazolium, oxazolium, triazolium, phosphonium, ammonium, and guanidinium.

5. The process of claim 1 wherein the anion is selected from one or more members of the group consisting of acetate, aminoacetate, ascorbate, benzoate, catecholate, citrate, dialkylphosphate, formate, fumarate, gallate, glycolate, glyoxylate, iminodiacetate, isobutyrate, kojate, lactate, levulinate, oxalate, pivalate, propionate, pyruvate, salicylate, succinamate, succinate, tiglate, tetrafluoroborate, tetrafluoroethanesulfonate, tropolonate, [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆], [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]₋, [(CF₃CFHCF₂SO₂)₂N]⁻, F⁻, and anions represented by the structure of the following formula: 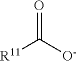
wherein R¹¹ is selected from the group consisting of:
(i) —CH₃, —C₂H₅, or C₁ to C₁₇ straight-chain, branched or cyclic alkane or alkene, optionally substituted with at least one member selected from the group consisting of Cl, Br, F, I, OH, NH₂ and SH;
(ii) —CH₃, —C₂H₅, or C₁ to C₁₇ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₁ to C₁₇ unsubstituted heteroaryl having one to three heteroatoms independently selected from the group consisting of O, N, Si and S; and
(iv) C₆ to C₁₀ substituted aryl, or C₁ to C₁₇ substituted heteroaryl having one to three heteroatoms independently selected from the group consisting of O, N, Si and S; and wherein said substituted aryl or substituted heteroaryl has one to three substituents independently selected from the group consisting of:
(A) —CH₃, —C₂H₅, or C₁ to C₁₇ straight-chain, branched or cyclic alkane or alkene, optionally substituted with at least one member selected from the group consisting of Cl, Br, F, I, OH, NH₂ and SH,
(B) OH,
(C) NH₂, and
(D) SH.

6. The process of claim 1 wherein the fluorinated vinyl monomer is vinyl fluoride or vinylidene fluoride.

7. The process of claim 6 wherein the fluorinated vinyl monomer is vinyl fluoride.

8. The process of claim 1 wherein the ionic liquid is selected from one or members of the group consisting of trihexyltetradecyl phosphonium bis(trifluoromethanesulfonyl)imide, 1-butyl-3-methylimidazolium dicyanimide, 1-butyl-3-methylimidazolium 1,1,2,3,3,3-hexafluoropropanesulfonate, 1-ethyl-3-methylimidazolium bis(trifluoromethylsulfonyl)imide, 1-butyl-3-methylpyridinium tetrafluoroborate, and 1-methyl-3-octylimidazolium 1,1,2,2-tetrafluoroethanesulfonate.

9. The process of claim 8 wherein the ionic liquid is trihexyltetradecyl phosphonium bis(trifluoromethanesulfonyl)imide.

10. The process of claim 1 further comprising the step of recovering the fluorinated polymer from the product mixture.

11. The process of claim 1 wherein the water-soluble free radical initiator is selected from the group consisting of organic peroxides, hydroperoxides, water-soluble salts of inorganic peracids, and azo compounds.

12. The process of claim 1 wherein the biphasic reaction medium contains about 5% to about 95% of the aqueous solution by weight relative to the total weight of the biphasic reaction medium.
